(19) United States
(12) Patent Application Publication
(10) Pub. No.: US 2013/0124879 A1
(43) Pub. Date: May 16, 2013

(54) CONTROLLING DATA READING MODE OF MEMORY

(71) Applicants: Yong Zhang, Shenzhen (CN); Yuan Li, Shenzhen (CN); Zhi Jiang, Shenzhen (CN); Xiaofei Li, Shenzhen (CN); Jian Sun, Shenzhen (CN)

(72) Inventors: Yong Zhang, Shenzhen (CN); Yuan Li, Shenzhen (CN); Zhi Jiang, Shenzhen (CN); Xiaofei Li, Shenzhen (CN); Jian Sun, Shenzhen (CN)

(73) Assignee: NVIDIA CORPORATION, Santa Clara, CA (US)

(21) Appl. No.: 13/398,731

(22) Filed: Feb. 16, 2012

(30) Foreign Application Priority Data
Nov. 10, 2011 (CN) 201110354755.8

(51) Int. Cl. G06F 1/30

(52) U.S. Cl. 713/300

(57) ABSTRACT

An embodiment of the invention includes a device for controlling data reading mode of a hard disk host apparatus. The device comprises a power converter circuit, a power supply toggle-switching circuit, a hard disk access port selection module, a hard disk host converter module, and a power control module. The power control module judges whether the motherboard supplies power for the apparatus in order to select the power supply mode and data transmission channel for the hard disk. If the motherboard supplies power, then power is supplied to the hard disk via the motherboard and the hard disk host controller is selected to provide the data transmission channel for the hard disk. If the motherboard supplies no power, then power is supplied to the hard disk via the external device receptacle and the hard disk host converter module is selected to provide the data transmission channel for the hard disk.

### CROSS-REFERENCE TO RELATED APPLICATION

This patent application claims the benefit and priority of the co-pending Chinese Patent Application No. 201110354755.8, by Yong ZHANG et al., filed on Nov. 10, 2011, Attorney Docket Number P2011172, which is hereby incorporated by reference.

### BACKGROUND

Usually, many users store a variety of data with a hard disk (HD) of a hard disk host apparatus (such as portable computers). However, the user cannot conveniently and timely read the data stored by the hard disk when the hard disk host apparatus fails to boot up due to a failure, or the user has no time, or is it not convenient to charge the hard disk host apparatus.

### SUMMARY

Thus, a technology overcoming the above problems is needed to conveniently and quickly read the data stored by a hard disk of a hard disk host apparatus when the hard disk cannot be normally accessed due to non-HD failure.

Various embodiments in accordance with the present invention include a device for controlling data reading mode of hard disk host apparatus. In an embodiment, the device comprises a power converter circuit, which is used for converting a voltage in order to supply power to the hard disk; a power supply toggle-switching circuit, which is used for selectively supplying power to the hard disk from the hard disk host apparatus or from the power converter circuit; a hard disk access port selection module, which is used for controlling selectively data transmission of the hard disk via the hard disk host controller or via the hard disk host converter module; a hard disk host converter module, which is used for converting the data transmission mode of the hard disk from the external device mode to the mode utilized by the hard disk host apparatus; and a power control module, which is used for detecting a motherboard power supply situation of the hard disk host apparatus in order to provide control signals for the power supply toggle-switching circuit and the hard disk access port selection module.

In an embodiment, the device is implemented with the motherboard of the hard disk host apparatus, and is independent of other circuits of the motherboard.

In an embodiment, the power converter circuit converts supply voltage supplied by an external device receptacle of the hard disk host apparatus into the working voltage utilized by the hard disk of the hard disk host apparatus.

In an embodiment, the external device receptacle includes a Universal Serial Bus (USB) receptacle.

In an embodiment, the power converter circuit converts a supply voltage of +5 V (volts) supplied by the USB receptacle of the hard disk host apparatus into a working voltage of +12 V and +3.3 V as utilized by the hard disk of the hard disk host apparatus.

In an embodiment, input terminals of the power supply toggle-switching circuit are coupled to the power converter circuit and the motherboard power supply circuit of the hard disk host apparatus, respectively. An output terminal of the power supply toggle-switching circuit is coupled to the hard disk of the hard disk host apparatus.

In an embodiment, the hard disk access port selection module uses Side-band Port Selection Mechanism to select one of the hard disk host converter module and the hard disk host controller of the motherboard of the hard disk host apparatus to provide the data transmission channel for the hard disk.

In an embodiment, the hard disk host converter module is a chip which serves as a bridge between the external device interface and the hard disk interface of the hard disk host apparatus.

In an embodiment, the hard disk interface is selected from SATA (Serial Advanced Technology Attachment) interface, IDE (Integrated Drive Electronics) interface, SCSI (Small Computer System Interface) interface, and Fibre Channel interface.

In an embodiment, an input terminal of the power control module is used for detecting the motherboard power supply situation of the hard disk host apparatus, and the output terminals of the power control module are coupled to the power supply toggle-switching circuit and the hard disk access port selection module, respectively.

In an embodiment, the hard disk host apparatus is selected from portable computers, desktop computers, and tablet computers.

An embodiment in accordance with the present invention also includes a method for controlling data reading mode of a hard disk host apparatus. The method comprises the steps of:

a) detecting a motherboard power supply situation of the hard disk host apparatus;

b) if the motherboard is detected not to supply power for the hard disk host apparatus, selecting a power supply from a power converter circuit for the hard disk, and selecting a data transmission channel via a hard disk host converter module for the hard disk;

c) if the motherboard is detected to supply power for the hard disk host apparatus, selecting a power supply from the hard disk host apparatus for the hard disk, and selecting a data transmission channel via the hard disk host controller for the hard disk.

In an embodiment, the step a) is implemented by a power control module.

In an embodiment, the step b) further comprises a step of sending a control signal to the power supply toggle-switching circuit through the power control module in order that the power supply toggle-switching circuit selects the power converter circuit to supply power for the hard disk via the external device of the hard disk host apparatus.

In an embodiment, the step b) further comprises a step of sending a control signal to the hard disk access port selection module through the power control module in order that the hard disk access port selection module starts the hard disk host converter module to provide the data transmission channel for the hard disk.

In an embodiment, the step c) further comprises a step of sending a control signal to the power supply toggle-switching circuit through the power control module in order that the power supply toggle-switching circuit selects the hard disk host apparatus to supply power for the hard disk.

In an embodiment, the step c) further comprises a step of sending a control signal to the hard disk access port selection module through the power control module in order that the hard disk access port selection module starts the hard disk host controller of the motherboard of the hard disk host apparatus to supply the data transmission channel for the hard disk.

In an embodiment, the condition where the motherboard does not supply power for the hard disk host apparatus includes when the motherboard is not powered or the motherboard is powered but the motherboard cannot be booted up normally.

In an embodiment, the method is implemented by a dedicated device implemented with the motherboard of the hard disk host apparatus.

In an embodiment, the dedicated device is independent of other circuits of the motherboard.

An embodiment of the invention includes an apparatus comprising a memory device, a controller for the memory device, a power supply, and an external device receptacle. In addition, the apparatus comprises a switching circuit coupled to the power supply and the external device receptacle. The switching circuit is coupled to supply power to the memory device from the power supply or the external device receptacle. Furthermore, the apparatus comprises a selector module coupled to the controller and the external device receptacle. The selector module is coupled to control data transmission between the memory device and the controller or the external device receptacle.

An embodiment of the invention includes a method comprising: determining if a power supply of an apparatus is supplying power to the apparatus; if the power supply is not supplying power to the apparatus, supplying power to a memory device of the apparatus via an external device receptacle of the apparatus; and if the power supply is not supplying power to the apparatus, supplying a data transmission channel between the memory device and the external device receptacle.

The method of the previous paragraph can further include: if the power supply is supplying power to the apparatus, supplying a data transmission channel between the memory device and a memory device controller of the apparatus. Moreover, the method of the previous paragraph can further include: if the power supply is supplying power to the apparatus, supplying power to the memory device of the apparatus via the power supply. Note that in an embodiment, the method of the previous paragraph can include all the elements described within the present paragraph.

According to various embodiments of the present invention, data stored by the hard disk of the hard disk host apparatus can be quickly accessed or read while the hard disk host apparatus is powered off or cannot be booted up due to non-HD failure.

While particular embodiments in accordance with the invention have been specifically described within this Summary, it is noted that the invention and the claimed subject matter are not limited in any way by these embodiments.

### BRIEF DESCRIPTION OF THE DRAWINGS

The accompanying drawings are included to provide a further understanding of various embodiments in accordance with the invention, and are incorporated in and constitute a part of this specification. The drawings illustrate various embodiments of the invention and, together with the description, serve to explain principles of various embodiments in accordance with the invention.

FIG. 1 illustrates a diagram of a structure of a device in accordance with an embodiment of the invention for controlling data reading mode of a hard disk host apparatus.

FIG. 2 illustrates a flow chart of a method in accordance with an embodiment of the invention for controlling data reading mode of a hard disk host apparatus.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details or with equivalents thereof. In other instances, well known methods, procedures, components, and circuits have not been described in detail as not to unnecessarily obscure aspects of the invention.

In order to thoroughly understand various embodiments in accordance with the invention, a detailed structure will be presented in the following description. In order to avoid confusion of various embodiments in accordance with the invention, some technical characteristics known by those skilled in the art are not described.

Certainly, the implementation of various embodiments in accordance with the present invention are not limited to the special details known by those skilled in the art. Besides the description of an example embodiment of the invention, the present invention can also be implemented with other methods in accordance with various embodiments.

Various embodiments in accordance with the present invention relate generally to circuits on a motherboard of a hard disk host apparatus and, in particular, to a device and a method for controlling data reading mode of the hard disk host apparatus.

An embodiment in accordance with the present invention includes a device which can control data reading mode of a hard disk host apparatus. When the hard disk host apparatus fails to boot up due to a failure, or the user has no time, or it is not convenient to charge the hard disk host apparatus, or under the circumstance that the hard disk host apparatus is not booted up, a user can use other external devices (such as other computers and smart phones) to read the data stored by the hard disk of the hard disk host apparatus through an external device receptacle of the hard disk host apparatus.

A portable computer is an example embodiment used to explain a technical solution in accordance with an embodiment of the invention. For those skilled in the art, the technical solution in accordance with an embodiment of the invention also applies to other hard disk host apparatus, such as desktop computers and tablet computers. In an example embodiment, an external device receptacle of the portable computer is a Universal Serial Bus (USB) receptacle and, for those skilled in the art, the USB receptacle can be replaced with other receptacles matched with interfaces of the external devices. In an example embodiment, the hard disk of the portable computer is a SATA (Serial Advanced Technology Attachment) hard disk and, for those skilled in the art, the technical solution in accordance with an embodiment of the invention also applies to control the reading mode of data stored by other kinds of hard disks by replacing the SATA interface with the interface utilized to access or read the corresponding hard disk, such as IDE (Integrated Drive Electronics) interface, SCSI (Small Computer System Interface) interface, and Fibre Channel interface.

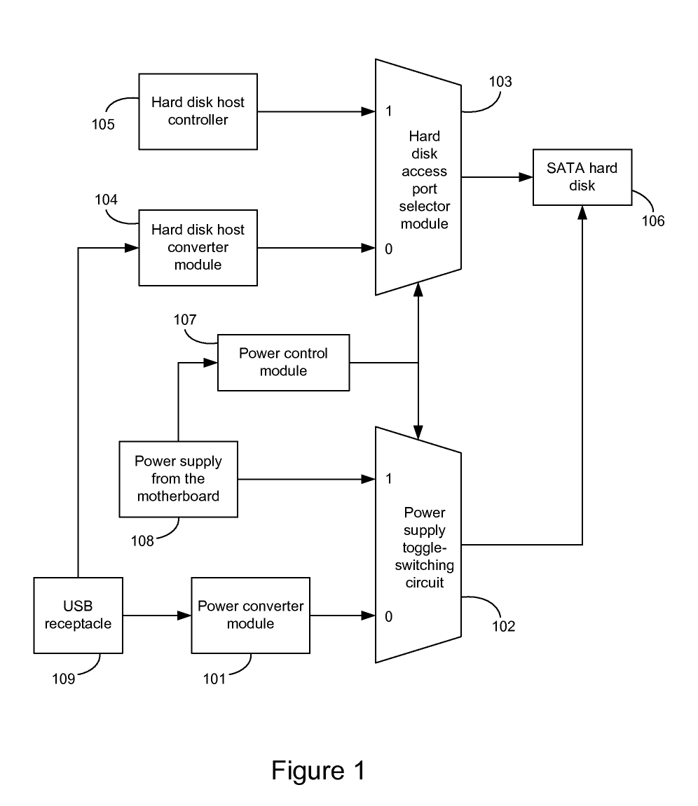

A device in accordance with an embodiment of the invention is implemented with a motherboard of a portable computer, and the device is independent of other circuits of the motherboard. FIG. 1 illustrates a diagram of a structure of the device in accordance with an embodiment of the invention. In one embodiment, the device comprises five parts: a power converter circuit 101, a power supply toggle-switching circuit 102, a hard disk access port selection module 103, a hard disk host converter module 104, and a power control module 107.

In an embodiment, the power converter circuit 101 is used for converting a voltage in order to supply power to a hard disk 106. In an example embodiment, the power converter circuit 101 converts a supply voltage of +5 V (volts) supplied by an external device of the portable computer via a USB receptacle 109 into a working voltage of +12 V and +3.3 V as utilized by the SATA hard disk 106.

In an embodiment, the power supply toggle-switching circuit 102 is used for selectively supplying power to the hard disk 106 from the hard disk host apparatus or from the power converter circuit 101. Input terminals of the power supply toggle-switching circuit 102 are coupled to the power converter circuit 101 and a motherboard power supply circuit 108 of the hard disk host apparatus, respectively. An output terminal of the power supply toggle-switching circuit 102 is coupled to the hard disk 106 of the hard disk host apparatus. In an example embodiment, the power supply toggle-switching circuit 102 selects one of the motherboard power supply mode and the USB receptacle power supply mode to supply power for the SATA hard disk 106. While the motherboard power supply 108 exists in concurrence with the USB receptacle power supply 109, the motherboard power supply 108 is given preference in an embodiment to supply power for the SATA hard disk 106.

In an embodiment, the hard disk access port selection module 103 is used for selectively controlling data transmission of the hard disk 106 via the hard disk host controller 105 or via the hard disk host converter module 104. In an embodiment, the hard disk access port selection module 103 uses Side-band Port Selection Mechanism to select one of the hard disk host converter module 104 and the hard disk host controller 105 to provide the data transmission channel for the hard disk 106. In an example embodiment, when the hard disk access port selection module 103 starts (or selects) the hard disk host converter module 104, a user can couple other USB hosts to the USB receptacle 109 of the portable computer in order to read the data stored by the SATA hard disk 106. In an embodiment, when the hard disk access port selection module 103 starts (or selects) the hard disk host controller 105, a user directly accesses the data stored by the SATA hard disk 106 through the portable computer.

In an embodiment, the hard disk host converter module 104 is a chip which serves as a bridge between the external device interface and the hard disk interface of the hard disk host apparatus. In an embodiment, the hard disk host converter module 104 is used for converting the data transmission mode of the hard disk 106 from an external device mode to the mode utilized by the hard disk host apparatus. In an example embodiment, the hard disk host converter module 104 is a chip which serves as a bridge between the USB interface and the SATA interface of the portable computer. In an embodiment, when the hard disk access port selection module 103 selects the hard disk host converter module 104, the hard disk host converter module 104 converts a request command from another USB host to access the SATA hard disk 106 via the USB receptacle 109 of the portable computer from the USB mode to the SATA mode and transmits the converted request command to the SATA hard disk 106. Then, in an embodiment, the hard disk host converter module 104 converts a request command of transmitting data sent from the SATA hard disk 106 from the SATA mode to the USB mode and transmits the converted request command to the other USB host in order to receive the data.

In an embodiment, the power control module 107 is used for detecting the situation of the motherboard power supply 108 of the hard disk host apparatus in order to provide control signals for the power supply toggle-switching circuit 102 and the hard disk access port selection module 103. In an embodiment, an input terminal of the power control module 107 is used for detecting the situation of the motherboard power supply 108 of the hard disk host apparatus. In an embodiment, output terminals of the power control module 107 are coupled to the power supply toggle-switching circuit 102 and the hard disk access port selection module 103, respectively. For example, in an embodiment, while the motherboard is detected to supply power 108 for the hard disk host apparatus, the power control module 107 sends digital signal 1 as the control signal; and while the motherboard is detected not to supply power 108 for the hard disk host apparatus, the power control module 107 sends digital signal 0 as the control signal.

A working principle of the device in accordance with an embodiment of the invention is as follows.

In an embodiment, while the motherboard is detected to supply power 108 for the hard disk host apparatus, the power supply toggle-switching circuit 102 receives the control signal sent from the power control module 107, and then switches to the motherboard power supply 108 mode to supply power for the SATA hard disk 106. Meanwhile, the hard disk access port selection module 103 receives the control signal sent from the power control module 107, and then selects the hard disk host controller 105 to supply the data transmission channel for the SATA hard disk 106. At this time, a user accesses the data stored by the SATA hard disk 106 through the portable computer.

In an embodiment, while the motherboard is detected not to supply power 108 for the hard disk host apparatus or the BIOS (basic input/output system) of the motherboard is forced to output an error-detection signal, namely, the motherboard is not powered or the motherboard is powered but the motherboard cannot be booted up normally, the user can couple another USB host to the USB receptacle 109 of the portable computer. At this time, the power supply toggle-switching circuit 102 receives the control signal sent from the power control module 107, and then switches to the USB receptacle 109 power supply mode to supply power for the SATA hard disk 106. Meanwhile, the hard disk access port selection module 103 receives the control signal sent from the power control module 107, and then selects the hard disk host converter module 104. The hard disk host converter module 104 converts the USB interface mode into the SATA interface mode to supply the data transmission channel for the SATA hard disk 106 and the user reads the data stored by the SATA hard disk 106 via the USB host coupled to the portable computer. While the external power from the USB receptacle 109 is supplied for the SATA hard disk 106, the power converter circuit 101 converts supply voltage supplied by the USB receptacle 109 of the portable computer into the working voltage as needed by the SATA hard disk 106.

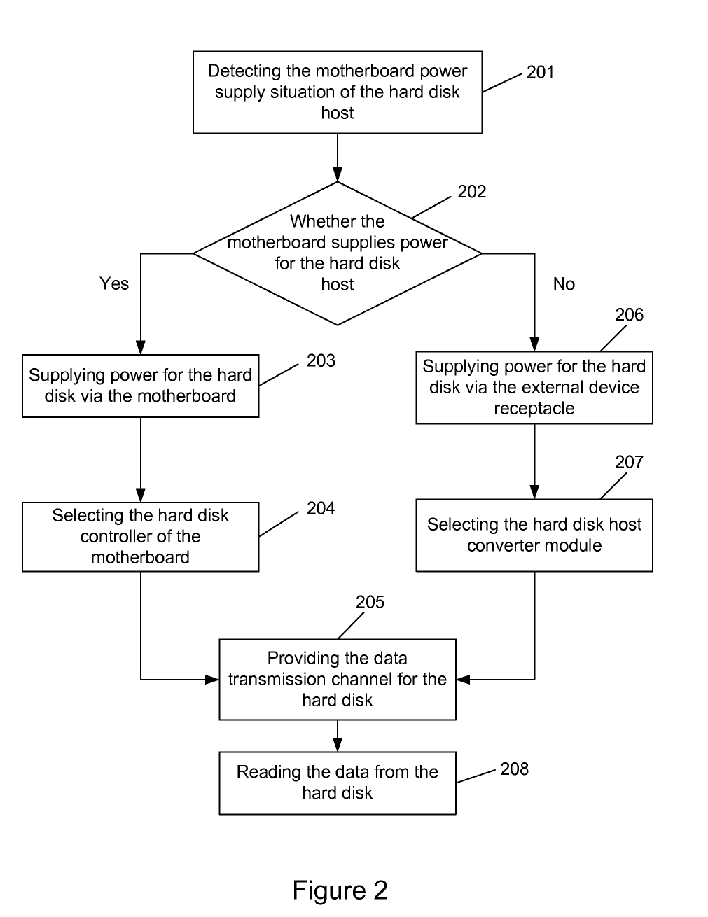

An embodiment in accordance with the present invention also includes a method which can control data reading mode of a hard disk host apparatus. The steps of the method are shown in FIG. 2.

At step 201, a motherboard power supply situation is detected for the hard disk host apparatus.

At step 202, it is determined whether the motherboard supplies power for the hard disk host apparatus in order to select the power supply mode and the data transmission channel for a hard disk. If it is determined at step 202 that the motherboard is supplying power, at step 203, power is supplied for the hard disk via the motherboard and, at step 204, a hard disk host controller of the motherboard is started or selected to supply at step 205 the data transmission channel for the hard disk. If it is determined at step 202 that the motherboard is not supplying power, at step 206, power is supplied for the hard disk via an external device receptacle and, at step 207, a hard disk host converter module is started or selected to provide at step 205 the data transmission channel for the hard disk.

At step 208, the data is read from the hard disk.

The present invention has been described through the various above example embodiments. However, it should be appreciated that the various above example embodiments are illustrative only and are not intended to be in any way limiting. In addition, those skilled in the art should realize that the present invention is not limited to the various above example embodiments and various modifications, adaptations, and alternative embodiments thereof may be made within the scope and spirit of the present invention. The invention is further defined by the following claims.

What is claimed is:

1. An apparatus comprising:
a memory device;
a controller for the memory device;
a power supply;
an external device receptacle;
a switching circuit coupled to the power supply and the external device receptacle, the switching circuit coupled to supply power to the memory device from the power supply or the external device receptacle; and
a selector module coupled to the controller and the external device receptacle, the selector module coupled to control data transmission between the memory device and the controller or the external device receptacle.

2. The apparatus of claim 1, further comprising:
a control module for determining if the power supply is supplying power to the apparatus, the control module is coupled to the power supply, the switching circuit, and the selector module.

3. The apparatus of claim 2, wherein if the control module determines the power supply is not supplying power to the apparatus, the control module is for causing the switching circuit to supply power to the memory device from the external device receptacle.

4. The apparatus of claim 2, wherein if the control module determines the power supply is not supplying power to the apparatus, the control module is for causing the selector module to control data transmission between the memory device and the external device receptacle.

5. The apparatus of claim 2, wherein if the control module determines the power supply is supplying power to the apparatus, the control module is for causing the switching circuit to supply power to the memory device from the power supply.

6. The apparatus of claim 2, wherein if the control module determines the power supply is supplying power to the apparatus, the control module is for causing the selector module to control data transmission between the memory device and the controller.

7. The apparatus of claim 2, wherein the control module, the switching circuit, and the selector module are implemented with a motherboard of the apparatus and are independent of other circuits of the motherboard.

8. The apparatus of claim 1, wherein external device receptacle comprises a Universal Serial Bus receptacle.

9. A method comprising:
determining if a power supply of an apparatus is supplying power to the apparatus;
if the power supply is not supplying power to the apparatus, supplying power to a memory device of the apparatus via an external device receptacle of the apparatus; and
if the power supply is not supplying power to the apparatus, supplying a data transmission channel between the memory device and the external device receptacle.

10. The method of claim 9, further comprising:
if the power supply is supplying power to the apparatus, supplying a data transmission channel between the memory device and a memory device controller of the apparatus.

11. The method of claim 10, further comprising:
if the power supply is supplying power to the apparatus, supplying power to the memory device of the apparatus via the power supply.

12. The method of claim 9, further comprising:
if the power supply is supplying power to the apparatus, supplying power to the memory device of the apparatus via the power supply.

13. The method of claim 9, wherein a control module of the apparatus performs the determining, the control module is coupled to the power supply.

14. The method of claim 9, wherein external device receptacle comprises a Universal Serial Bus receptacle.

15. The method of claim 9, wherein said apparatus comprises a tablet computer or portable computer.

16. An apparatus comprising:
a hard disk;
a controller for the hard disk;
a power supply;
an external device receptacle;
a switching circuit coupled to the power supply and the external device receptacle, the switching circuit coupled to supply power to the memory device from the power supply or the external device receptacle; and
a selector module coupled to the controller and the external device receptacle, the selector module coupled to control data transmission between the hard disk and the controller or the external device receptacle.

17. The apparatus of claim 16, further comprising:
a control module for determining if the power supply is supplying power to the apparatus, the control module is coupled to the power supply, the switching circuit, and the selector module.

18. The apparatus of claim 17, wherein if the control module determines the power supply is not supplying power to the apparatus, the control module is for causing the switching circuit to supply power to the hard disk from the external device receptacle.

19. The apparatus of claim 17, wherein if the control module determines the power supply is not supplying power to the apparatus, the control module is for causing the selector module to control data transmission between the hard disk and the external device receptacle.

20. The apparatus of claim 17, wherein if the control module determines the power supply is supplying power to the apparatus, the control module is for causing the selector module to control data transmission between the memory device and the controller.
